(19) United States
(12) Patent Application Publication
(10) Pub. No.: US 2025/0310188 A1
(43) Pub. Date: Oct. 2, 2025

(54) METHOD AND APPARATUS FOR CREATING A CONNECTOR

(71) Applicant: Beijing Zitiao Network Technology Co., Ltd., Beijing (CN)

(72) Inventors: Denglin WANG, Beijing (CN); Xin CHENG, Beijing (CN); Jiale SHEN, Beijing (CN); Fengyuan TIAN, Beijing (CN)

(21) Appl. No.: 18/862,922

(22) PCT Filed: Jun. 5, 2023
(86) PCT No.: PCT/CN2023/098262

§ 371 Date: Nov. 4, 2024

(30) Foreign Application Priority Data
Jun. 23, 2022 (CN) 202210720120.3

(51) Int. Cl. H04L 41/0813; H04L 69/08

(52) U.S. Cl. CPC H04L 41/0813; H04L 69/08

(57) ABSTRACT

The application discloses a method for creating a connector, wherein a user may trigger a connector creation operation in a first page, and a client may, in response to the connector creation operation, display a second page that is a connector configuration page. The user may trigger an interface parameter configuration operation in the second page, and correspondingly, the server may acquire interface parameters configured by the user in response to the interface parameter configuration operation triggered by the user in the second page, and generate a target connector based on the interface parameters. The target connector may be configured to convert a message encapsuled using a first data protocol to a message encapsuled using a second data protocol.

### CROSS-REFERENCE TO RELATED APPLICATIONS

The present application is a U.S. National Stage application under 35 U.S.C. § 371 of International Application No. PCT/CN2023/098262, as filed on Jun. 5, 2023, which claims a priority from the Chinese patent application No. 202210720120.3, entitled “METHOD AND APPARATUS FOR CREATING A CONNECTOR” filed with the CNIPA on Jun. 23, 2022, the disclosure of which is incorporated herein by reference in its entirety.

### TECHNICAL FIELD

The present application relates to the field of computer technologies, and in particular, to a method and an apparatus for creating a connector.

### BACKGROUND

In some scenarios, there may be a need for accessing an application running in an intranet environment from an extranet environment. For example, a user accesses an application running in an intranet environment through an integration platform deployed on an extranet.

At present, accessing an application running in an intranet environment from an extranet environment may be accomplished through a connector. In particular, a corresponding connector may be generated by way of software codes written by a user.

### SUMMARY OF THE INVENTION

Embodiments of the present application provide method and apparatus for creating a connector.

In a first aspect, an embodiment of the present application provides a method for creating a connector, the method comprising:
in response to a connector creation operation triggered by a user in a first page, displaying a second page that is a connector configuration page;
in response to an interface parameter configuration operation triggered by a user in a second page, acquiring interface parameters configured by the user; and
based on the interface parameters, generating a target connector, wherein the target connector is configured to covert a message encapsuled using a first data protocol into a message encapsuled using a second data protocol.

Optionally, in response to an interface parameter configuration operation triggered by a user in the second page, acquiring interface parameters configured by the user comprises:
in response to an interface configuration file uploading operation triggered by the user in the second page, acquiring the interface configuration file, and parsing the interface configuration file to acquire the interface parameters.

Optionally, in response to an interface parameter configuration operation triggered by a user in the second page, acquiring interface parameters configured by the user comprises:
in response to an interface parameter input operation triggered by the user in the second page, acquiring interface parameters input by the user.

Optionally, the method further comprises:
in response to an error code configuration operation triggered by the user in the second page, acquiring error code information configured by the user; and
generating a target connector based on the interface parameters comprises:
generating the target connector based on the interface parameters and the error code information.

Optionally, the method further comprises:
in response to a trigger configuration operation triggered by the user in the second page, acquiring trigger information configured by the user, wherein the trigger information is configured to indicate an application which is deployed in an intranet and interacts with the target connector; and
generating a target connector based on the interface parameters comprises:
generating the target connector based on the interface parameters and the trigger information.

Optionally, generating a target connector based on the interface parameters comprises:
generating the target connector based on the interface parameters and a predetermined connector template.

Optionally, the first data protocol is a universal data protocol, and the second data protocol is a private data protocol; or, the first data protocol is a private data protocol, and the second data protocol is a universal data protocol.

Optionally, the target connector is configured to enable a client deployed in a public network to have mutual access with an application deployed in an intranet, the client deployed in the public network using the first data protocol to encapsule a message, and the application using the second data protocol to encapsule a message; or, the client deployed in the public network using the second data protocol to encapsule a message, and the application using the first data protocol to encapsule a message.

In a second aspect, an embodiment of the present application provides an apparatus for creating a connector, the apparatus comprising:
a display unit configured to display, in response to a connector creation operation triggered by a user in a first page, a second page that is a connector configuration page;
a first acquisition unit configured to acquire, in response to an interface parameter configuration operation triggered by a user in a second page, interface parameters configured by the user; and
a generation unit configured to generate a target connector based on the interface parameters, the target connector configured to convert a message encapsuled using a first data protocol into a message encapsuled using a second data protocol.

Optionally, the first acquisition unit is configured to:
in response to an interface configuration file uploading operation triggered by the user in the second page, acquire the interface configuration file, and parse the interface configuration file to acquire the interface parameters.

Optionally, the first acquisition unit is configured to:
in response to an interface parameter input operation triggered by the user in the second page, acquire interface parameters input by the user.

Optionally, the apparatus further comprises:
a second acquisition unit configured to acquire, in response to an error code configuration operation triggered by the user in the second page, error code information configured by the user; and
the generation unit is configured to:
generate the target connector based on the interface parameters and the error code information.

Optionally, the apparatus further comprises:
a third acquisition unit configured to acquire, in response to a trigger configuration operation triggered by the user in the second page, trigger information configured by the user, the trigger information configured to indicate an application deployed in an intranet and interacting with the target connector; and
the generation unit is configured to:
generate the target connector based on the interface parameters and the trigger information.

Optionally, the generation unit is configured to:
generate the target connector based on the interface parameters and a predetermined connector template.

Optionally, the first data protocol is a universal data protocol, and the second data protocol is a private data protocol; or, the first data protocol is a private data protocol, and the second data protocol is a universal data protocol.

Optionally, the target connector is configured to enable a client deployed in a public network to perform mutual access with an application deployed in an intranet, wherein the client deployed in the public network uses the first data protocol to encapsule a message, and the application uses the second data protocol to encapsule a message; or, the client deployed in the public network uses the second data protocol to encapsule a message, and the application uses the first data protocol to encapsule a message.

In a third aspect, an embodiment of the present application provides a device, the device comprising a processor and a memory;
the processor configured to execute instructions stored in the memory to cause the device to perform the method of any item of the first aspect.

In a fourth aspect, an embodiment of the present application provides a computer-readable storage medium, including instructions that instruct a device to perform the method according to any item of the first aspect.

In a fifth aspect, an embodiment of the present application provides a computer program product which, when run on a computer, causes the computer to perform the method according to any item of the first aspect.

An embodiment of the present application provides a method for creating a connector, and in an example, a user may trigger a connector creation operation in a first page, and accordingly, a client may display a second page in response to the connector creation operation, wherein the second page is a connector configuration page. After the second page is displayed, the user may trigger an interface parameter configuration operation in the second page, and correspondingly, the server may acquire interface parameters configured by the user in response to the interface parameter configuration operation triggered by the user in the second page, and further generate a target connector based on the interface parameters. The target connector may be configured to convert a message encapsuled using a first data protocol to a message encapsuled using a second data protocol.

### DESCRIPTION OF THE DRAWINGS

In order to more clearly illustrate the embodiments of the present application or the technical solutions in the related art, the drawings used in the embodiments or the description of the related art will be briefly described below. Apparently, the drawings in the following description are only some embodiments described in the present application, and it is also possible for those skilled in the art to obtain other drawings based on the drawings without creative efforts.

FIG. 1 is a diagram illustrating a system architecture provided according to an embodiment of the present application;

FIG. 2 is a flow chart illustrating a method for creating a connector provided according to an embodiment of the present application;

FIG. 3 is a schematic structural diagram illustrating an apparatus for creating a connector provided according to an embodiment of the present application.

### DETAILED DESCRIPTION

In order to make those skilled in the art better understand the solutions of the present application, the technical solutions in the embodiments of the present application will be clearly and completely described below with reference to the drawings in the embodiments of the present application, and it is obvious that the described embodiments are only a part instead of all of the embodiments of the present application. All other embodiments, which can be obtained by those skilled in the art without making any creative effort based on the embodiments in the present application, belong to the protection scope of the present application.

The inventors of the application find that in some scenarios, a user can access an application running in an intranet through an integration platform deployed in the extranet. For example, a user queries application data of an application running in an intranet environment through an integration platform deployed in an extranet.

With regard to the integrated platform, it should be noted that:
the integration platform is a platform formed by combining the integration of an application system with an integration framework, and the problems of high integration cost and low efficiency of enterprises are solved through lower construction cost and higher integration capability. In this embodiment, the integration platform may integrate multiple systems corresponding to an enterprise, and provide a unified operation portal, so that a user may complete a corresponding operation through the operation portal without entering each system for operation, thereby improving the service processing efficiency.

In an example, the unified operation portal may be an operation portal for accessing an application in an intranet, and a user may trigger a corresponding operation through the operation portal, so as to access the application in the intranet. By way of example:
a web page corresponding to the integration platform may include an access portal for accessing an application A in an intranet, and a user may trigger an operation for accessing the application A through the access portal, and accordingly, after the user triggers an operation for accessing the application A, the integration platform may display an associated page of the application A, and the user may input information (for example, a keyword) of data that needs to be accessed specifically in the associated page, and after the user inputs the information and determines an operation for the information trigger, a server corresponding to the integration platform may generate a corresponding data access request based on the information input by the user, and send the data access request to the application A.

Currently, integrated platforms support a universal data protocol. In one example, after a user triggers an operation for accessing a certain application (e.g., application A) deployed on the intranet, the integration platform may generate a data access request using a universal data protocol. The application deployed on the intranet may be developed using a private data protocol or a universal data protocol. If the application A is developed using a private data protocol, the protocol supported by the application A is the private data protocol. Therefore, for this case, even if the application A receives the data access request using the universal data protocol, the data access request cannot be correctly parsed, and accordingly, the access to the application A fails.

In this case, the data access request using the universal data protocol may be processed by a connector deployed in the intranet to obtain a data access request using a private data protocol, and further, the data access request using the private data protocol may be sent to the application A for access to the application A. In one example, the data access request using the universal data protocol may be first received by a host agent deployed in an intranet, and then the host agent may forward the data access request using the universal data protocol to the connector.

In addition, besides sending a request using a private data protocol to the application A, the host agent can also enable a user to access other applications (for example, application B) supporting a universal data protocol, which are deployed in an intranet, through the aforementioned integration platform.

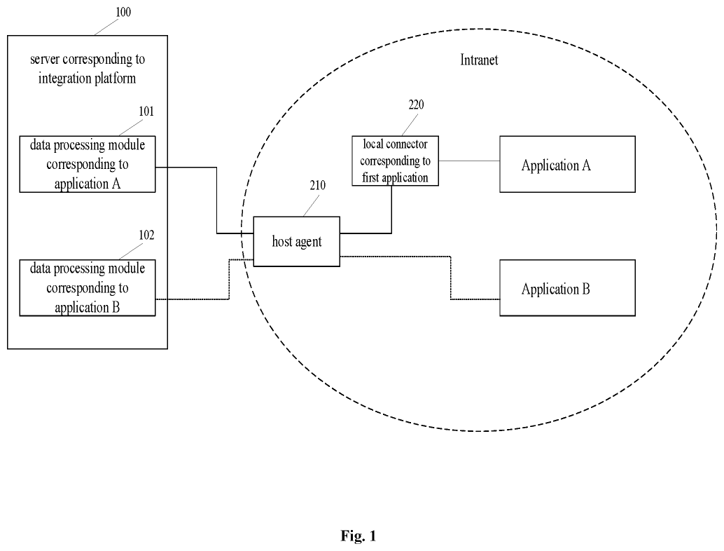

As can be understood, FIG. 1 is a schematic diagram of a system architecture provided according to an embodiment of the present application.

In one example, the integration platform may include an access portal for accessing an application A of the intranet and an access portal for accessing an application B of the intranet. Correspondingly, a server 100 corresponding to the integration platform deployed in the extranet may include a data processing module 101 corresponding to the application A and a data processing module 102 corresponding to the application B.

Wherein:
the data processing module 101 is configured to process data related to the application A, and in one example, the data processing module 10, for example, may generate the request using the universal data protocol as mentioned above.

The data processing module 102 is configured to process data related to the application B.

The data processing module 101 and the application A may communicate with each other through a host agent 210 deployed in the intranet and a local connector 220 corresponding to the application A.

The data processing module 102 and the application B may communicate with each other through the host agent 210.

It should be noted that FIG. 1 is only shown for convenience of understanding the solution provided by the embodiment of the present application, and is not to be construed as limiting the embodiment of the present application.

Currently, the aforementioned connector (e.g., connector 220) may be generated by way of software code written by a user. However, in this way, the efficiency for generating the connector is low.

In order to solve the above problem, embodiments of the present application provide a method and an apparatus for creating a connector.

Various non-limiting embodiments of the present application are described in detail below with reference to the accompanying drawings.

### Exemplary Methods

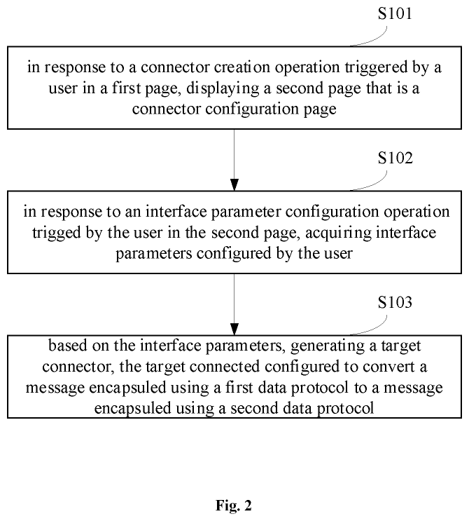

Referring to FIG. 2, which is a flowchart of a method for creating a connector provided according to an embodiment of the present application. In this embodiment, the method may be applied to a client, for example, and the method may create a target connector for a user. The target connector may be configured to convert a message encapsuled using a first data protocol to a message encapsuled using a second data protocol.

In one example, the target connector may enable a client deployed in a public network to have mutual access with an application (e.g., a first application) deployed in an intranet. For example, through the target connector, a user may trigger, on the integration platform, an operation for accessing a first application on an intranet, thereby enabling access to the first application. For this case:
in one example, the first data protocol may be a universal data protocol and the second data protocol may be a private data protocol. For example, the first data protocol may be a universal data protocol supported by an integration platform, and the second data protocol may be a private data protocol supported by the first application.

In yet another example, the first data protocol may be a private data protocol and the second data protocol may be a universal data protocol. For example, the first data protocol may be a universal data protocol supported by the first application, and the second data protocol may be a private data protocol supported by the integration platform.

The method may, for example, comprise the steps of: S101-S103.

S101: in response to a connector creation operation triggered by a user in a first page, displaying a second page that is a connector configuration page.

In one example, the first page may be a web page.

As an example, the first page may include a first control for triggering the connector creation operation, and a user may trigger the connector creation operation through the first control. For example, a user may click on the first control, thereby triggering the connector creation operation. After the user triggers the connector creation operation, the client may display a second page as a connector configuration page in response to the connector creation operation. The user may configure the configuration information for the connector via the second page.

S102: in response to an interface parameter configuration operation triggered by a user in a second page, acquiring interface parameters configured by the user.

In one example, considering that a first application in the intranet may receive data (e.g., a data access request) from the extranet through a corresponding interface, accordingly, it may send data out through the corresponding interface. Accordingly, communication between the target connector and the first application is also performed via the interface. Therefore, it is particularly important to configure interface parameters when configuring the target connector. In view of this, in an example, after the client displays the second page, the user may trigger an interface parameter configuration operation in the second page, wherein the interface parameter configuration operation is for configuring interface parameters of the target connector, and the interface parameters may be interface parameters corresponding to the application in the intranet. Correspondingly, the client may acquire interface parameters configured by the user in response to the interface parameter configuration operation.

In one example, the interface parameter configuration operation may be an interface configuration file uploading operation. For example, if the above-mentioned application in the intranet has a standard Open Application Programming Interface Specification (OAS) description file, the user may trigger an interface configuration file uploading operation in the second page and upload the OAS description file. In this case, the client may acquire the interface configuration file uploaded by the user and parse the interface configuration file to obtain the interface parameter.

In yet another example, the interface parameter configuration operation may be an interface parameter input operation. For example, the second page may include an interface parameter input area, and a user may input corresponding interface parameters in the interface parameter input area. In this case, the client may acquire the interface parameters input by the user. In one example, if the first application does not include the standard OAS description file, the user may input the interface parameters with reference to an interface document of the first application.

S103: generating a target connector based on the interface parameters, wherein the target connector is configured for converting a message encapsuled using a first data protocol into a message encapsuled using a second data protocol.

After acquiring the interface parameters, the client may generate the target connector based on the acquired interface parameters. The generation of the target connector as mentioned herein may be, for example, generating software codes corresponding to the target connector.

In one example, in a specific implementation, at S103, the target connector may be generated according to the interface parameters and a corresponding connector generation logic.

In yet another example, in a specific implementation, at S103, the target connector may be generated based on the interface parameters and a predetermined connector template. For example, the interface parameters may be added to the connector template to obtain the target connector. As an example, the connector template may be a software code template corresponding to a connector, and after the interface parameters are added to the software code template, software codes corresponding to the target connector may be obtained.

In one example, considering that a client deployed on an extranet may have some abnormalities when performing data interaction with a first application. When the abnormality occurs, corresponding processing measures may be performed. Therefore, when parameters are configured for the target connector, error code information may be further configured, wherein the error code information may be information related to error codes, and one error code may correspond to one or more abnormalities.

In view of this, in one example, the user may further trigger an error code configuration operation in the second page, and accordingly, after the user triggers the error code configuration operation, the client may obtain error code information configured by the user. For example, the second page may include a second control, through which the user may trigger an error code configuration operation, and accordingly, the client may display an error code configuration page, the user may input error code information in the error code configuration page, and accordingly, the client may obtain the error code information input by the user.

In this case, in a specific implementation, at S103, the client may generate the target connector based on the interface parameters and the error code information. As one example, the client may generate the target connector based on the interface parameters, the error code information, and a connector template. For example, the client may input the interface parameters and the error code information into the connector template, thereby obtaining the target connector.

As described above, the target connector may be configured to enable a client deployed in a public network to perform mutual access with a first application deployed in an intranet. In this case:
in one example, the first application may be a default application deployed in the intranet.

In yet another example, the first application may be configured by a user. As an example, the user may trigger a trigger configuration operation in the second page, and accordingly, the client may obtain trigger information configured by the user in response to the trigger configuration operation triggered by the user in the second page. By way of example: the second page may include a third control, through which the user may trigger the trigger configuration operation, and accordingly, the client may display a trigger configuration page, the user may input trigger information in the trigger configuration page, and accordingly, the client may obtain the trigger information input by the user.

In this case, in a specific implementation, at S103, the client may generate the target connector based on the interface parameters and the trigger information. As one example, the client may generate the target connector based on the interface parameters, the trigger information, and a connector template. For example, the client may input the interface parameters and the trigger information into the connector template, thereby obtaining the target connector.

In yet another example, if a user triggers both an error code configuration operation and a trigger configuration operation, in a specific implementation, at S103, the client may generate the target connector based on the interface parameters, the error code information and the trigger information. As one example, the client may generate the target connector based on the interface parameters, the error code information, the trigger information, and a connector template. For example, the client may input the interface parameters, the error code information, and the trigger information into the connector template, thereby obtaining the target connector.

It can be seen that, with the solution provided by the embodiment of the present application, a user does not need to write software codes corresponding to a target connector to generate the target connector, but instead, the user may create the target connector by triggering corresponding operations (for example, the aforementioned connector creation operation and interface parameter configuration operation, and further, the connector creation operation, the interface parameter configuration operation, and the error code configuration operation and the trigger configuration operation). It is less difficult for a user to trigger the aforementioned operations than writing software codes corresponding to a target connector, since writing software codes corresponding to the target connector requires certain programming capabilities, while triggering said operations by the user has a lower requirement on the programming capabilities. Therefore, it is more efficient for a user to trigger the aforementioned operations to create the target connector than writing software codes corresponding to the target connector. Therefore, by using the present solution, the efficiency of creating the target connector can be improved.

### Exemplary Devices

Based on the method provided by the above embodiments, the embodiments of the present application further provide an apparatus, which is described below with reference to the accompanying drawings.

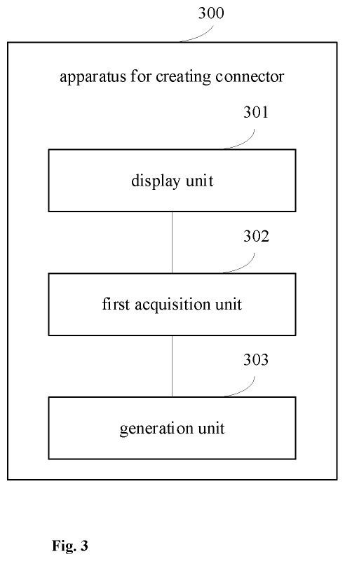

Referring to FIG. 3, which is a schematic structural diagram of an apparatus for creating a connector provided according to an embodiment of the present application. The apparatus 300 may specifically include, for example, a display unit 301, a first acquisition unit 302 and a generation unit 303.

The display unit 301 is configured to display a second page in response to a connector creation operation triggered by a user in a first page, the second page being a connector configuration page.

The first acquisition unit 302 is configured to acquire interface parameters configured by a user in response to an interface parameter configuration operation triggered by the user in the second page.

The generation unit 303 is configured to generate a target connector based on the interface parameters, wherein the target connector is configured to convert a message encapsuled using a first data protocol to a message encapsuled using a second data protocol.

Optionally, the first acquisition unit 302 is configured to:
in response to an interface configuration file uploading operation triggered by the user in the second page, acquire the interface configuration file, and parse the interface configuration file to obtain the interface parameters.

Optionally, the first acquisition unit 302 is configured to:
in response to an interface parameter input operation triggered by the user in the second page, acquire interface parameters input by the user.

Optionally, the apparatus further comprises:
a second acquisition unit configured to acquire, in response to error code configuration operation triggered by the user in the second page, error code information configured by the user; and
the generation unit 303 is configured to:
generate the target connector based on the interface parameters and the error code information.

Optionally, the apparatus further comprises:
a third acquisition unit configured to acquire trigger information configured by the user in response to a trigger configuration operation triggered by the user in the second page, wherein the trigger information is configured to indicate an application deployed in an intranet and interacting with the target connector; and
the generation unit 303 is configured to:
generate the target connector based on the interface parameters and the trigger information.

Optionally, the generation unit 303 is configured to:
generate the target connector based on the interface parameters and a predetermined connector template.

Optionally, the first data protocol is a universal data protocol, and the second data protocol is a private data protocol; or, the first data protocol is a private data protocol, and the second data protocol is a universal data protocol.

Optionally, the target connector is configured to enable a client deployed in a public network to perform mutual access with an application deployed in an intranet, wherein the client deployed in the public network uses the first data protocol to encapsule a message, and the application uses the second data protocol to encapsule a message; or, the client deployed in the public network uses the second data protocol to encapsule a message, and the application uses the first data protocol to encapsule a message.

Since the apparatus 300 is an apparatus corresponding to the method provided in the above method embodiments, and the specific implementation of each unit of the apparatus 300 is the same as that of the above method embodiments. Thus, for the specific implementation of each unit of the apparatus 300, reference may be made to the description of the above method embodiments, and details will not repeated here.

The embodiments of the application also provide a device, which comprises a processor and a memory, wherein:
the processor is configured to execute instructions stored in the memory to cause the device to perform a method for creating a connector according to any of the above method embodiments.

The embodiments of the present application provide a computer-readable storage medium, which includes instructions for instructing a device to perform a method for creating a connector according to any one of the above method embodiments.

The embodiments of the present application provide a computer program product, which, when run on a computer, causes the computer to perform the method for creating a connector according to any of the above method embodiments.

Other embodiments of the application will be apparent to those skilled in the art from consideration of the specification and practice of the application disclosed herein. The application is intended to cover any variations, usages, or adaptations of the application following general principles of the application and including such departures from the present disclosure within known or customary practice in the art to which the application pertains. The specification and examples shall be considered as exemplary only, with a true scope and spirit of the application being indicated by the following claims.

It will be appreciated that the application is not limited to the precise arrangements that have been described above and shown in the drawings, and that various modifications and changes can be made without departing from the scope thereof. The scope of the application is limited only by the appended claims.

The above description is only for the purpose of illustrating preferred embodiments of the present application and should not be taken as limiting the scope of the present application, which is intended to cover any modifications, equivalents, improvements, etc. within the protection scope of the present application.

1. A method for creating a connector, the method comprising:
in response to a connector creation operation triggered by a user in a first page, displaying a second page that is a connector configuration page;
in response to an interface parameter configuration operation triggered by the user in the second page, acquiring interface parameters configured by the user; and
generating, based on the interface parameters, a target connector, wherein the target connector is configured to convert a message encapsuled using a first data protocol into a message encapsuled using a second data protocol.

2. The method according to claim 1, wherein in response to an interface parameter configuration operation triggered by a user in the second page, acquiring interface parameters configured by the user comprises:
in response to an interface configuration file uploading operation triggered by the user in the second page, acquiring the interface configuration file, and parsing the interface configuration file to acquire the interface parameters.

3. The method according to claim 1, wherein in response to an interface parameter configuration operation triggered by a user in the second page, acquiring interface parameters configured by the user comprises:
in response to an interface parameter input operation triggered by the user in the second page, acquiring interface parameters input by the user.

4. The method according to claim 1, the method further comprising:
in response to an error code configuration operation triggered by the user in the second page, acquiring error code information configured by the user; and
generating a target connector based on the interface parameters comprises:
generating the target connector based on the interface parameters and the error code information.

5. The method according to claim 1, the method further comprising:
in response to a trigger configuration operation triggered by the user in the second page, acquiring trigger information configured by the user, wherein the trigger information is configured to indicate an application which is deployed in an intranet and interacts with the target connector; and
generating a target connector based on the interface parameters comprises:
generating the target connector based on the interface parameters and the trigger information.

6. The method according to claim 1, wherein generating a target connector based on the interface parameters comprises:
generating the target connector based on the interface parameters and a predetermined connector template.

7. The method according to claim 1, wherein the first data protocol is a universal data protocol, and the second data protocol is a private data protocol; or, the first data protocol is a private data protocol, and the second data protocol is a universal data protocol.

8. The method according to claim 1, wherein the target connector is configured to enable a client deployed in a public network to have mutual access with an application deployed in an intranet, the client deployed in the public network using the first data protocol to encapsule a message, and the application using the second data protocol to encapsule a message; or, the client deployed in the public network using the second data protocol to encapsule a message, and the application using the first data protocol to encapsule a message.

9. (canceled)

10. A device, the device comprising a processor and a memory;
wherein the processor is configured to execute instructions stored in the memory to cause the device to perform a method for creating a connector, comprising:
in response to a connector creation operation triggered by a user in a first page, displaying a second page that is a connector configuration page;
in response to an interface parameter configuration operation triggered by the user in the second page, acquiring interface parameters configured by the user; and
generating, based on the interface parameters, a target connector, wherein the target connector is configured to convert a message encapsuled using a first data protocol into a message encapsuled using a second data protocol.

11. A non-transitory computer-readable storage medium, comprising instructions that instruct a device to perform a method for creating a connector, comprising:
in response to a connector creation operation triggered by a user in a first page, displaying a second page that is a connector configuration page;
in response to an interface parameter configuration operation triggered by the user in the second page, acquiring interface parameters configured by the user; and
generating, based on the interface parameters, a target connector, wherein the target connector is configured to convert a message encapsuled using a first data protocol into a message encapsuled using a second data protocol.

12. (canceled)

13. The device according to claim 10, wherein in response to an interface parameter configuration operation triggered by a user in the second page, acquiring interface parameters configured by the user comprises:
in response to an interface configuration file uploading operation triggered by the user in the second page, acquiring the interface configuration file, and parsing the interface configuration file to acquire the interface parameters.

14. The device according to claim 10, wherein in response to an interface parameter configuration operation triggered by a user in the second page, acquiring interface parameters configured by the user comprises:
in response to an interface parameter input operation triggered by the user in the second page, acquiring interface parameters input by the user.

15. The device according to claim 10, wherein the processor is further configured to execute instructions stored in the memory to cause the device to perform the steps of:
in response to an error code configuration operation triggered by the user in the second page, acquiring error code information configured by the user; and
generating a target connector based on the interface parameters comprises:
generating the target connector based on the interface parameters and the error code information.

16. The device according to claim 10, wherein the processor is further configured to execute instructions stored in the memory to cause the device to perform the steps of:
in response to a trigger configuration operation triggered by the user in the second page, acquiring trigger information configured by the user, wherein the trigger information is configured to indicate an application which is deployed in an intranet and interacts with the target connector; and
generating a target connector based on the interface parameters comprises:
generating the target connector based on the interface parameters and the trigger information.

17. The device according to claim 10, wherein generating a target connector based on the interface parameters comprises:
generating the target connector based on the interface parameters and a predetermined connector template.

18. The non-transitory computer-readable storage medium according to claim 11, wherein in response to an interface parameter configuration operation triggered by a user in the second page, acquiring interface parameters configured by the user comprises:
in response to an interface configuration file uploading operation triggered by the user in the second page, acquiring the interface configuration file, and parsing the interface configuration file to acquire the interface parameters.

19. The non-transitory computer-readable storage medium according to claim 11, wherein in response to an interface parameter configuration operation triggered by a user in the second page, acquiring interface parameters configured by the user comprises:
in response to an interface parameter input operation triggered by the user in the second page, acquiring interface parameters input by the user.

20. The non-transitory computer-readable storage medium according to claim 11, wherein the instructions further instruct the device to perform the steps of:
in response to an error code configuration operation triggered by the user in the second page, acquiring error code information configured by the user; and
generating a target connector based on the interface parameters comprises:
generating the target connector based on the interface parameters and the error code information.

21. The non-transitory computer-readable storage medium according to claim 11, the instructions further instruct the device to perform the steps of:
in response to a trigger configuration operation triggered by the user in the second page, acquiring trigger information configured by the user, wherein the trigger information is configured to indicate an application which is deployed in an intranet and interacts with the target connector; and
generating a target connector based on the interface parameters comprises:
generating the target connector based on the interface parameters and the trigger information.

22. The non-transitory computer-readable storage medium according to claim 11, wherein generating a target connector based on the interface parameters comprises:
generating the target connector based on the interface parameters and a predetermined connector template.
